(19) United States
(12) Patent Application Publication
(10) Pub. No.: US 2026/0234908 A1
(43) Pub. Date: Aug. 13, 2026

(54) WORK VEHICLE

(71) Applicant: KUBOTA CORPORATION, Osaka (JP)

(72) Inventors: Hidetaka YANAI, Osaka (JP); Shunpei SHITOKIDEN, Osaka (JP)

(73) Assignee: KUBOTA CORPORATION, Osaka (JP)

(21) Appl. No.: 19/469,821

(22) PCT Filed: Mar. 12, 2024
(86) PCT No.: PCT/JP2024/009557

§ 371 Date: Sep. 26, 2025

(30) Foreign Application Priority Data
Mar. 31, 2023 (JP) 2023-056860

(51) Int. Cl. E02F 9/22

(52) U.S. Cl. CPC E02F 9/2267; E02F 9/2285

(57) ABSTRACT

A work vehicle includes: a first oil supply passage causing hydraulic oil in a first hydraulic pump to be supplied to a first work device; and a second oil supply passage connected to the first oil supply passage and a mixing valve. The mixing valve is switchable between a mixing position allowing hydraulic oil in a second hydraulic pump to be supplied to the first oil supply passage through the second oil supply passage and a diverting position preventing the hydraulic oil in the second hydraulic pump from being supplied to the first oil supply passage and the second oil supply passage. The work vehicle includes a release unit configured to switch the mixing valve to the diverting position based on a load applied to the first work device.

### TECHNICAL FIELD

The present invention relates to a configuration of a work vehicle to supply hydraulic oil to a work device provided for the work vehicle.

### BACKGROUND ART

In Patent Literature 1, a first hydraulic pump that can supply hydraulic oil to a work device is provided. For example, in an operation in a livestock shed or an operation in a residential area, the rotation speed of a motor unit (an engine, an electric motor, or the like) for driving the first hydraulic pump may be set to a low value to suppress noise.

When the rotation speed of the motor unit is decreased, hydraulic oil in the first hydraulic pump to be supplied to the work device may become insufficient. In view of this, in Patent Literature 1, hydraulic oil in a second hydraulic pump is supplied to an oil supply passage via a selector valve, so that the hydraulic oil in the first hydraulic pump is mixed with the hydraulic oil in the second hydraulic pump and supplied to the work device. Hereby, hydraulic oil for the work device is secured.

In Patent Literature 1, a low-pressure relief valve is connected to the second hydraulic pump. In a case where the hydraulic oil in the first hydraulic pump and the hydraulic oil in the second hydraulic pump are mixed and supplied to the work device, when a load applied to the work device increases, the low-pressure relief valve is opened to avoid a decrease in the rotation speed of the motor unit.

### CITATION LIST

### Patent Literature

Patent Literature 1: Japanese Unexamined Utility Model Application Publication No. 5-22657 (see reference signs 10, 16, 18, 20, 21 in FIG. 2)

### SUMMARY OF INVENTION

### Technical Problem

In Patent Literature 1, in a case where a load applied to the work device increases in a state where the hydraulic oil in the first hydraulic pump and the hydraulic oil in the second hydraulic pump are mixed and supplied to the work device, the decrease in the rotation speed of the motor unit is avoided by opening the low-pressure relief valve. However, there is such a concern that the temperature of the hydraulic oil may rise due to the low-pressure relief valve being opened.

In a case where the low-pressure relief valve is opened, a load is applied to both the first hydraulic pump and the second hydraulic pump, and therefore, there is such a concern that the first hydraulic pump and the second hydraulic pump may incur high pressure loss. In view of this, there is room for improvement in that the pressure loss is minimized or that the rise in hydraulic oil temperature is limited.

An object of the present invention is to minimize pressure loss and limit the rise in hydraulic oil temperature in a case where a high load is applied to a work device in a work vehicle while hydraulic oil in a first hydraulic pump and hydraulic oil in a second hydraulic pump are mixed and supplied to the work device.

### Solution to Problem

A work vehicle according to the present invention includes: a first hydraulic pump; a second hydraulic pump; a first work device; a first oil supply passage causing hydraulic oil in the first hydraulic pump to be supplied to the first work device; a mixing valve to which hydraulic oil in the second hydraulic pump is supplied; a second oil supply passage connected to the first oil supply passage and the mixing valve; and a release unit configured to switch the mixing valve from a mixing position to a diverting position based on a load applied to the first work device, the mixing position being a position allowing the hydraulic oil in the second hydraulic pump to be supplied to the first oil supply passage through the second oil supply passage, the diverting position being a position preventing the hydraulic oil in the second hydraulic pump from being supplied to the first oil supply passage and the second oil supply passage.

In the present invention, in response to the mixing valve being switched to the mixing position while the hydraulic oil in the first hydraulic pump is supplied to the first work device through the first oil supply passage, the hydraulic oil in the second hydraulic pump is supplied to the first oil supply passage from the mixing valve through the second oil supply passage, so that the hydraulic oil in the first hydraulic pump and the hydraulic oil in the second hydraulic pump are mixed and supplied to the first work device.

In the present invention, when a load applied to the first work vehicle increases in the aforementioned state, the mixing valve is switched to the diverting position due to the release unit, so that the load applied to the second hydraulic pump decreases, thereby reducing pressure loss in the second hydraulic pump. Hereby, in terms of the first hydraulic pump and the second hydraulic pump, the pressure loss in the second hydraulic pump is reduced, thereby making it possible to reduce the pressure loss in the whole work vehicle.

In the present invention, in response to increasing of the load applied to the first work device, the mixing valve is switched to the diverting position, and therefore, unlike Patent Literature 1, a relief valve connected to the first oil supply passage and the second oil supply passage is not opened. This makes it possible to limit the rise in hydraulic oil temperature.

In the present invention, the work vehicle may further include a second work device, and the hydraulic oil in the second hydraulic pump may be supplied to the second work device and then supplied to the mixing valve from the second work device.

In the present invention, the second hydraulic pump is not an exclusive pump for supplying the hydraulic oil to the first oil supply passage, and after the hydraulic oil in the second hydraulic pump is supplied to the second work device and then supplied from the second work device to the mixing valve, the hydraulic oil is supplied from the mixing valve to the first oil supply passage.

Hereby, in a case where the mixing valve is in the diverting position in the work vehicle including the first work device and the second work device, when the rotation speed of a motor unit for driving the first hydraulic pump and the second hydraulic pump is set to a high value, the first work device can be reasonably operated by the first hydraulic pump, and the second work device can be reasonably operated by the second hydraulic pump.

In a case where the second work device is a work device that does not require much hydraulic oil (for example, a power steering device, a travel speed control device, or the like), the rotation speed of the motor unit for driving the first hydraulic pump and the second hydraulic pump is set to a low value, so that the first work device and the second work device can be reasonably operated by the first hydraulic pump and the second hydraulic pump even when the mixing valve is switched to the mixing position.

In the present invention, the load applied to the first work device may be hydraulic pressure in the second oil supply passage, and the release unit may switch the mixing valve to the diverting position in response to the hydraulic pressure in the second oil supply passage becoming higher than a setting pressure determined in advance.

In the present invention, the load applied to the first work device is recognized as the hydraulic pressure in the hydraulic oil in the second oil supply passage. The release unit switches the mixing valve to the diverting position in response to the hydraulic pressure in the second oil supply passage becoming higher than the setting pressure determined in advance.

Since the load applied to the first work device is recognized as the hydraulic pressure in the second oil supply passage, the load applied to the first work device can be recognized with accuracy, thereby allowing the release unit to switch the mixing valve to the diverting position with accuracy.

In the present invention, the mixing valve may be a pilot-operated valve biased to the diverting position and include a switching section configured to switch the mixing valve to the mixing position upon receipt of pilot hydraulic oil. The work vehicle may further include a selector valve, and a pilot oil passage connected to the switching section of the mixing valve and the selector valve. The selector valve may be switchable between (i) a first position allowing the pilot hydraulic oil to be supplied from the pilot oil passage to the switching section of the mixing valve to switch the mixing valve to the mixing position and (ii) a second position causing the pilot hydraulic oil to be discharged from the switching section of the mixing valve through the pilot oil passage to switch the mixing valve to the diverting position. The release unit may be a relief valve configured to switch the mixing valve to the diverting position by discharging the pilot hydraulic oil from the pilot oil passage in response to the hydraulic pressure in the second oil supply passage becoming higher than the setting pressure.

In the present invention, the mixing valve is a pilot-operated valve. In response to the selector valve being switched to the first position, the pilot hydraulic oil is supplied to the switching section of the mixing valve, so that the mixing valve is switched to the mixing position. In response to the selector valve being switched to the second position, the pilot hydraulic oil is discharged from the switching section of the mixing valve, so that the mixing valve is switched to the diverting position.

In the present invention, in response to the hydraulic pressure in the second oil supply passage becoming higher than the setting pressure while the selector valve is in the first position, the pilot hydraulic oil is discharged by the relief valve (the release unit) from the pilot oil passage connected to the switching section of the mixing valve and the selector valve. Even when the selector valve is in the first position, the pilot hydraulic oil is discharged by the relief valve (the release unit), so that the mixing valve is switched to the diverting position.

Hereby, an operation system for the mixing valve can be easily constituted by the pilot-operated mixing valve, the selector valve, the pilot oil passage, and the relief valve (the release unit).

In the present invention, the work vehicle may further include a check valve provided for the second oil supply passage and configured to prevent the hydraulic oil from the first oil supply passage from flowing toward the mixing valve, and the relief valve may discharge the pilot hydraulic oil from the pilot oil passage in response to the hydraulic pressure in a portion of the second oil supply passage between the first oil supply passage and the check valve becoming higher than the setting pressure.

In the present invention, the check valve configured to prevent the hydraulic oil from the first oil supply passage from flowing toward the mixing valve is provided for the second oil supply passage, and the check valve allows the second oil supply passage to have a portion in which the hydraulic pressure is stable (a portion between the first oil supply passage and the check valve). The relief valve works based on the portion with stable hydraulic pressure in the second oil supply passage (the portion between the first oil supply passage and the check valve).

In the present invention, since the relief valve works based on the portion with stable hydraulic pressure in the second oil supply passage, the load applied to the first work device is recognized with accuracy, thereby allowing the relief valve to switch the mixing valve to the diverting position with accuracy.

In the present invention, the pilot oil passage may include a reduced section provided between the selector valve and a portion connected to the relief valve.

In a case where the pilot hydraulic oil is supplied to the switching section of the mixing valve by the selector valve being switched to the first position and the mixing valve is switched to the mixing position, and in a case where the pilot hydraulic oil is discharged from the switching section of the mixing valve by the selector valve being switched to the second position and the mixing valve is switched to the diverting position, if the mixing valve is rapidly switched to the mixing position (the diverting position), the hydraulic oil in the second hydraulic pump is rapidly supplied to the first oil supply passage (the supply of the hydraulic oil is rapidly stopped), shock may be induced.

In the present invention, the pilot oil passage includes the reduced section between the selector valve and a portion connected to the relief valve.

When the selector valve is switched to the first position, the pilot hydraulic oil is gradually supplied to the switching section of the mixing valve through the selector valve (the first position) and the reduced section, thereby making it possible to suppress rapid switching of the mixing valve to the mixing position.

When the selector valve is switched to the second position, the pilot hydraulic oil is gradually discharged from the switching section of the mixing valve through the reduced section and the selector valve (in the second position), thereby making it possible to suppress rapid switching of the mixing valve to the diverting position.

This makes it possible to avoid the hydraulic oil in the second hydraulic pump from being rapidly supplied to the first hydraulic oil supply passage (or to avoid the supply of the hydraulic oil from rapidly stopping), thereby making it possible to suppress the induction of shock.

In the present invention, the work vehicle may further include an oil discharge passage connected to the pilot oil passage and including a reduced section and the relief valve.

In a case where the pilot hydraulic oil is discharged from the pilot oil passage through the relief valve so that the mixing valve is switched to the diverting position, if the mixing valve is rapidly switched to the diverting position, the supply of the hydraulic oil in the second hydraulic pump to the first oil supply passage is rapidly stopped, so that shock may be induced.

In the present invention, the oil discharge passage connected to the pilot oil passage includes the reduced section and the relief valve.

In a case where the pilot hydraulic oil is discharged from the pilot oil passage through the relief valve, the pilot hydraulic oil in the switching section of the mixing valve is gradually discharged through the reduced section and the relief valve, thereby making it possible to suppress rapid switching of the mixing valve to the diverting position.

This can avoid the rapid stop of the supply of the hydraulic oil in the second hydraulic pump to the first oil supply passage, thereby making it is possible to suppress the induction of shock.

In the present invention, the pilot oil passage may include a reduced section provided between the mixing valve and a portion connected to the relief valve.

In a case where the pilot hydraulic oil is supplied to the switching section of the mixing valve by the selector valve being switched to the first position and the mixing valve is switched to the mixing position, and in a case where the pilot hydraulic oil is discharged from the switching section of the mixing valve by the selector valve being switched to the second position and the mixing valve is switched to the diverting position, if the mixing valve is rapidly switched to the mixing position (the diverting position), the hydraulic oil in the second hydraulic pump is rapidly supplied to the first oil supply passage (the supply of the hydraulic oil is rapidly stopped), so that shock may be induced.

In a case where the pilot hydraulic oil is discharged from the pilot oil passage through the relief valve so that the mixing valve is switched to the diverting position, if the mixing valve is rapidly switched to the diverting position, the supply of the hydraulic oil in the second hydraulic pump to the first oil supply passage is rapidly stopped, so that shock may be induced.

In the present invention, the pilot oil passage includes the reduced section between the mixing valve and a portion connected to the relief valve.

In response to the selector valve being switched to the first position, the pilot hydraulic oil is gradually supplied to the switching section of the mixing valve through the selector valve (in the first position) and the reduced section, thereby making it possible to suppress rapid switching of the mixing valve to the mixing position.

In response to the selector valve being switched to the second position, the pilot hydraulic oil is gradually discharged from the switching section of the mixing valve through the reduced section and the selector valve (in the second position), thereby making it possible to suppress rapid switching of the mixing valve to the diverting position.

In a case where the pilot hydraulic oil is discharged from the pilot oil passage through the relief valve, the pilot hydraulic oil in the switching section of the mixing valve is gradually discharged through the reduced section and the relief valve, thereby making it possible to suppress rapid switching of the mixing valve to the diverting position.

This can avoid the hydraulic oil in the second hydraulic pump from being rapidly supplied to the first oil supply passage (the rapid stop of the supply of the hydraulic oil to the first oil supply passage), thereby making it is possible to suppress the induction of shock.

### BRIEF DESCRIPTION OF DRAWINGS

FIG. 1 is a left side view of a tractor;

FIG. 2 is a hydraulic circuit diagram illustrating a first hydraulic pump, a second hydraulic pump, a mixing valve (in a mixing position), a selector valve (in a first position), a pilot oil passage, a low-pressure relief valve, and so on;

FIG. 3 is a hydraulic circuit diagram illustrating a state where the mixing valve is switched to a diverting position by a relief valve being opened due to the hydraulic pressure in the pilot oil passage becoming higher than a second setting pressure in FIG. 2;

FIG. 4 is a hydraulic circuit diagram according to a first modification in the present invention;

FIG. 5 is a hydraulic circuit diagram according to a second modification in the present invention;

FIG. 6 is a hydraulic circuit diagram according to a fourth modification in the present invention; and

FIG. 7 is a hydraulic circuit diagram according to a sixth modification in the present invention.

### DESCRIPTION OF EMBODIMENTS

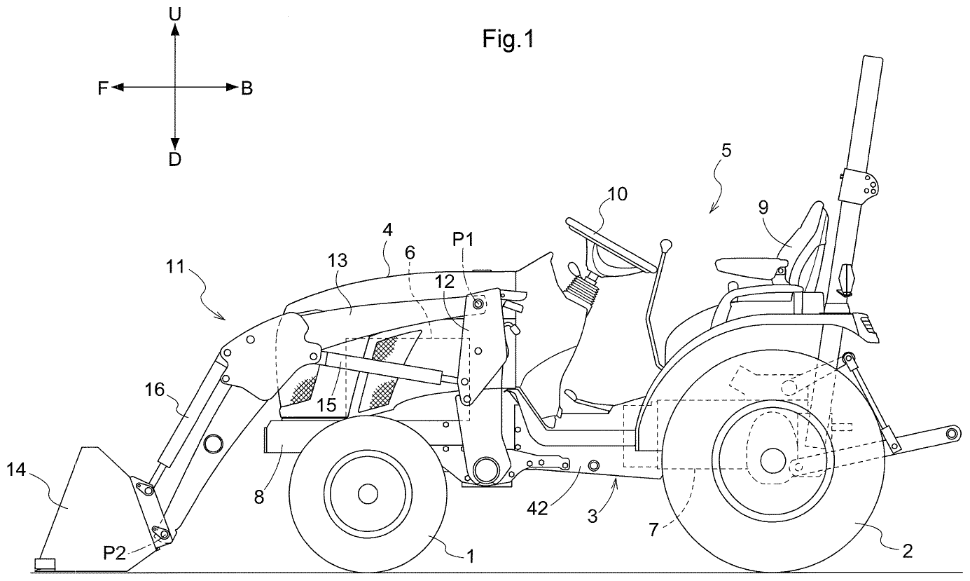

A tractor as an example of a work vehicle is illustrated in FIGS. 1 to 7. Here, F represents the front direction of the work vehicle, B represents the rear direction, U represents the upper direction, and D represents the lower direction.

### Overall Configuration of Tractor

As illustrated in FIG. 1, the tractor includes a body 3 held by right and left front wheels 1 and right and left rear wheels 2, a bonnet 4 provided in the front portion of the body 3, and a cab unit 5 provided in the rear portion of the body 3.

The body 3 includes an engine 6, a frame 42 coupled to the rear portion of the engine 6, a transmission case 7 coupled to the frame 42, a front frame 8 coupled to the front portion of the engine 6, and so on. The front wheels 1 are held by the front frame 8, and the rear wheels 2 are held by the rear portion of the transmission case 7. The engine 6 is covered with the bonnet 4. The cab unit 5 includes a driver seat 9 and a steering wheel 10 configured to steer the front wheels 1.

### Configuration of Front Loader

As illustrated in FIG. 1, a front loader 11 (corresponding to a first work device) is provided for the front portion of the body 3. The front loader 11 includes base frames 12, arms 13, a bucket 14, arm cylinders 15, bucket cylinders 16, and so on.

The base frames 12 on the right and left sides are coupled to the right portion and the left portion of the front portion of the body 3. The arms 13 on the right and left sides are held by respective upper portions of the base frames 12 in such a manner as to be swingable in the up-down direction around an axis P1 along the right-left direction. The arm cylinders 15 on the right and left sides are double-acting arm cylinders each connected to a corresponding arm 13 and a corresponding base frame 12.

The bucket 14 is held by respective front portions of the arms 13 in such a manner as to be swingable in the up-down direction around an axis P2 along the right-left direction, and bucket cylinders 16 as double-acting cylinders on the right and left sides are connected to the bucket 14 and their corresponding arms 13.

In response to the arm cylinders 15 extending or retracting, the arms 13 are swung in the up-down direction, and in response to the bucket cylinders 16 extending or retracting, the bucket 14 is swung in the up-down direction.

### Hydraulic Circuits of First Hydraulic Pump and Second Hydraulic Pump, and Configuration of Mixing Valve—1

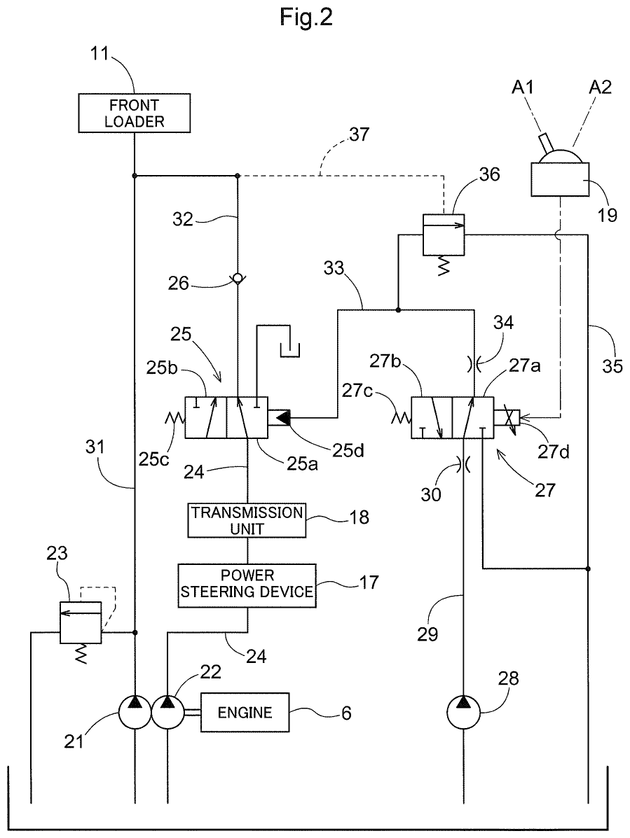

As illustrated in FIG. 2, a first hydraulic pump 21 and a second hydraulic pump 22 driven by the engine 6 are provided.

A first oil supply passage 31 is extended from the first hydraulic pump 21 such that the first oil supply passage 31 is connected to a service port (not illustrated) provided for the body 3. A hydraulic hose (not illustrated) is connected to the service port and the front loader 11 (the arm cylinders 15 and the bucket cylinders 16). Hereby, hydraulic oil in the first hydraulic pump 21 is supplied to the front loader 11 through the first oil supply passage 31.

A high-pressure relief valve 23 is connected to the first oil supply passage 31. In response to the pressure of the first oil supply passage 31 becoming higher than a relatively high first setting pressure determined in advance, the high-pressure relief valve 23 is opened.

A power steering device 17 (corresponding to a second work device) for the front wheels 1 is provided. A transmission device (not illustrated) for traveling is provided inside the transmission case 7 (see FIG. 1), and a hydraulic transmission unit 18 (corresponding to the second work device) configured to perform a shifting operation on the transmission device is provided.

An oil supply passage 24 is extended from the second hydraulic pump 22 and is connected to the power steering device 17 and the transmission unit 18. A mixing valve 25 is provided, and the oil supply passage 24 extended from the transmission unit 18 is connected to the mixing valve 25. A second oil supply passage 32 is extended from the mixing valve 25 and is connected to a portion of the first oil supply passage 31 which portion is downstream from a portion thereof to which the high-pressure relief valve 23 is connected.

The mixing valve 25 is a pilot-operated valve switchable between a mixing position 25a and a diverting position 25b and is biased to the diverting position 25b by a spring 25c. In response to pilot hydraulic oil with a predetermined pressure or more being supplied to a switching section 25d of the mixing valve 25, the mixing valve 25 is switched to the mixing position 25a against the spring 25c of the mixing valve 25.

The second oil supply passage 32 includes a check valve 26. The check valve 26 allows hydraulic oil from the mixing valve 25 to flow toward the first oil supply passage 31 and prevents hydraulic oil from the first oil supply passage 31 from flowing toward the mixing valve 25.

In response to the mixing valve 25 being switched to the mixing position 25a, hydraulic oil in the second hydraulic pump 22 is supplied to the first oil supply passage 31 through the power steering device 17, the transmission unit 18, the mixing valve 25 (in the mixing position 25a), the second oil supply passage 32, and the check valve 26.

In response to the mixing valve 25 being switched to the diverting position 25b, the hydraulic oil in the second hydraulic pump 22 is discharged after passing through the power steering device 17, the transmission unit 18, and the mixing valve 25 (in the diverting position 25b) and is not supplied to the first oil supply passage 31.

### Hydraulic Circuits of First Hydraulic Pump and Second Hydraulic Pump, and Configuration of Mixing Valve—2

With the above-mentioned configuration, as illustrated in FIG. 2, the first hydraulic pump 21, the second hydraulic pump 22, the front loader 11 (the first work device), the first oil supply passage 31 causing the hydraulic oil in the first hydraulic pump 21 to be supplied to the front loader 11 (the first work device), the mixing valve 25 to which the hydraulic oil in second hydraulic pump 22 is supplied, and the second oil supply passage 32 connected to the first oil supply passage 31 and the mixing valve 25 are provided.

The power steering device 17 (the second work device) and the transmission unit 18 (the second work device) are provided.

The hydraulic oil in the second hydraulic pump 22 is supplied to the power steering device 17 (the second work device) and the transmission unit 18 (the second work device) and then supplied to the mixing valve 25 from the power steering device 17 (the second work device) and the transmission unit 18 (the second work device).

The mixing valve 25 is switchable between the mixing position 25a allowing the hydraulic oil in the second hydraulic pump 22 to be supplied to the first oil supply passage 31 through the second oil supply passage 32 and the diverting position 25b preventing the hydraulic oil in the second hydraulic pump 22 from being supplied to the first oil supply passage 31 and the second oil supply passage 32.

The mixing valve 25 is a pilot-operated valve biased to the diverting position 25b and configured to be switched to the mixing position 25a in response to pilot hydraulic oil being supplied to the switching section 25d.

### Configuration of Selector Valve for Switching Mixing Valve—1

As illustrated in FIG. 2, a selector valve 27 is provided. An oil supply passage 29 from a pilot pump 28 is connected to the selector valve 27, and the oil supply passage 29 includes a reduced section 30.

A pilot oil passage 33 is connected to the switching section 25d of the mixing valve 25 and the selector valve 27, and the pilot oil passage 33 includes a reduced section 34.

The selector valve 27 is a solenoid-operated valve switchable between a first position 27a and a second position 27b and is biased to the second position 27b by a spring 27c. In response to operation electric power being supplied to a switching section 27d of the selector valve 27, the selector valve 27 is switched to the first position 27a against the spring 27c of the selector valve 27.

The cab unit 5 (see FIG. 1) includes an operating section 19 operable manually. In response to an operator operating the operating section 19 to a first operation position A1, operation electric power is supplied to the switching section 27d of the selector valve 27, so that the selector valve 27 is switched to the first position 27a.

In response to the selector valve 27 being switched to the first position 27a, pilot hydraulic oil in the pilot pump 28 is gradually supplied to the switching section 25d of the mixing valve 25 through the oil supply passage 29, the reduced section 30, the selector valve 27 (in the first position 27a), the pilot oil passage 33, and the reduced section 34, so that the mixing valve 25 is switched to the mixing position 25a.

In response to the operator operating the operating section 19 to the second operation position A2, the supply of the operation electric power to the switching section 27d of the selector valve 27 stops, so that the selector valve 27 is switched to the second position 27b by the spring 27c of the selector valve 27.

In response to the selector valve 27 being switched to the second position 27b, the pilot hydraulic oil is gradually discharged from the switching section 25d of the mixing valve 25 through the pilot oil passage 33, the reduced section 34, and the selector valve 27 (the second position 27b), so that the mixing valve 25 is switched to the diverting position 25b by the spring 25c of the mixing valve 25.

In response to the selector valve 27 being switched to the second position 27b, the pilot hydraulic oil is discharged from the switching section 25d of the mixing valve 25 through the reduced section 34. In the meantime, in response to the selector valve 27 being switched to the first position 27a, the pilot hydraulic oil in the pilot pump 28 is supplied to the switching section 25d of the mixing valve 25 through the reduced sections 30, 34. In view of this, the mixing valve 25 is slightly slowly switched to the mixing position 25a in comparison with a case where the mixing valve 25 is switched to the diverting position 25b.

### Configuration of Selector Valve for Switching Mixing Valve—2

With the above configuration, as illustrated in FIG. 2, the selector valve 27, and the pilot oil passage 33 connected to the switching section 25d of the mixing valve 25 and the selector valve 27 are provided.

The selector valve 27 is switchable between the first position 27a allowing the pilot hydraulic to be supplied from the pilot oil passage 33 to the switching section 25d of the mixing valve 25 to switch the mixing valve 25 to the mixing position 25a, and the second position 27b causing the pilot hydraulic oil to be discharged from the switching section 25d of the mixing valve 25 via the pilot oil passage 33 to switch the mixing valve 25 to the diverting position 25b.

### Configuration of Relief Valve for Switching Mixing Valve to Diverting Position upon Increase in Load Applied to Front Loader—1

As illustrated in FIG. 2, an oil discharge passage 35 is provided in such a manner that the oil discharge passage 35 is connected to a portion of the pilot oil passage 33 between the switching section 25d of the mixing valve 25 and the reduced section 34.

The oil discharge passage 35 includes a low-pressure relief valve 36 (corresponding to a release unit) (corresponding to a relief valve). A pilot oil passage 37 is extended from a portion of the second oil supply passage 32 between the first oil supply passage 31 and the check valve 26 and is connected to the low-pressure relief valve 36.

In response to the hydraulic pressure in the portion of the second oil supply passage 32 between the first oil supply passage 31 and the check valve 26 becoming higher than a relatively low second setting pressure (corresponding to a setting pressure) determined in advance, the low-pressure relief valve 36 is opened by pilot hydraulic oil in the pilot oil passage 37.

In this case, the second setting pressure to open the low-pressure relief valve 36 is determined to be lower than the first setting pressure to open the high-pressure relief valve 23.

### Configuration of Relief Valve for Switching Mixing Valve to Diverting Position upon Increase in Load Applied to Front Loade—2

The state illustrated in FIG. 2 is a state where the operating section 19 is operated to the first operation position A1, and the selector valve 27 is switched to the first position 27a, so that the pilot hydraulic oil in the pilot pump 28 is supplied to the switching section 25d of the mixing valve 25, and is also a state where the mixing valve 25 is switched to the mixing position 25a. That is, the hydraulic oil in the second hydraulic pump 22 is supplied to the first oil supply passage 31 through the power steering device 17, the transmission unit 18, the mixing valve 25 (the mixing position 25a), the second oil supply passage 32, and the check valve 26.

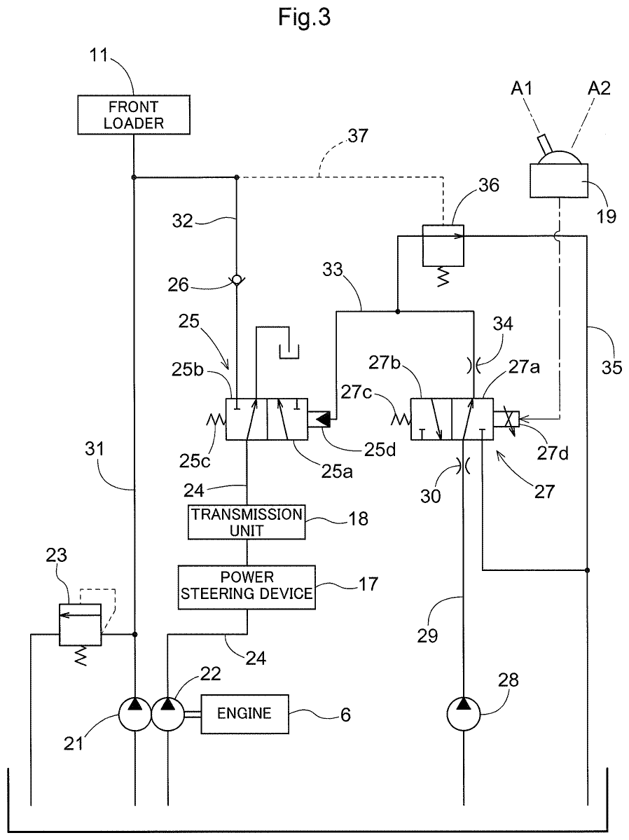

In the state illustrated in FIG. 2, when a load applied to the front loader 11 increases and the hydraulic pressure in the portion of the second oil supply passage 32 between the first oil supply passage 31 and the check valve 26 becomes higher than the second setting pressure, the low-pressure relief valve 36 is opened by the pilot hydraulic oil in the pilot oil passage 37, as illustrated in FIG. 3.

In response to the low-pressure relief valve 36 being opened, the pilot hydraulic oil in the pilot oil passage 33 is discharged via the low-pressure relief valve 36 and the oil discharge passage 35 even when the selector valve 27 is in the first position 27a (even when the pilot hydraulic oil in the pilot pump 28 is supplied to the pilot oil passage 33).

In response to the pilot hydraulic oil in the pilot oil passage 33 being discharged, the mixing valve 25 is switched to the diverting position 25b by the spring 25c of the mixing valve 25. In this case, since no reduced section is provided for the oil discharge passage 35, the pilot hydraulic oil in the pilot oil passage 33 is rapidly discharged, so that the mixing valve 25 is rapidly switched to the diverting position 25b.

In response to the mixing valve 25 being switched to the diverting position 25b, the hydraulic oil in the second hydraulic pump 22 is supplied to the power steering device 17 and the transmission unit 18 and is discharged from the mixing valve 25 (in the diverting position 25b) but is not supplied to the first oil supply passage 31.

### Configuration of Relief Valve for Switching Mixing valve to Diverting Position upon Increase in Load Applied to Front Loader—3

With the above configuration, as illustrated in FIGS. 2, 3, the low-pressure relief valve 36 (the release unit) (the relief valve) configured to switch the mixing valve 25 to the diverting position 25b based on the load applied to the front loader 11 (the first work device) is provided.

The load applied to the front loader 11 (the first work device) is the hydraulic pressure in the second oil supply passage 32.

In response to the hydraulic pressure in the second oil supply passage 32 becoming higher than the second setting pressure determined in advance, the low-pressure relief valve 36 (the release unit) (the relief valve) switches the mixing valve 25 to the diverting position 25b.

The low-pressure relief valve 36 (the release unit) (the relief valve) is a relief valve configured to switch the mixing valve 25 to the diverting position 25b by discharging the pilot hydraulic oil from the pilot oil passage 33, in response to the pressure of the second oil supply passage 32 becoming higher than the second setting pressure (a setting pressure).

The second oil supply passage 32 includes the check valve 26 that can prevent the hydraulic oil from the first oil supply passage 31 from flowing toward the mixing valve 25.

The low-pressure relief valve 36 (the release unit) (the relief valve) causes the pilot hydraulic oil to be discharged from the pilot oil passage 33, in response to the hydraulic pressure in the portion of the second oil supply passage 32 between the first oil supply passage 31 and the check valve 26 becoming higher than the second setting pressure (the setting pressure).

The reduced section 34 is provided for the pilot oil passage 33 to be disposed between a portion connected to the low-pressure relief valve 36 (the release unit) (the relief valve) and the selector valve 27.

### First Modification of Invention

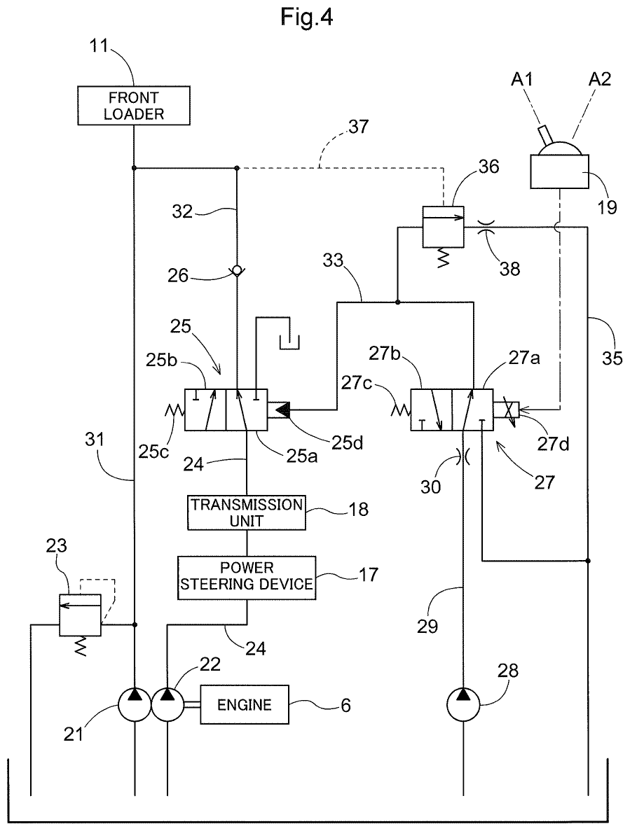

As illustrated in FIG. 4, instead of providing the reduced section 34 (see FIGS. 2, 3) provided for the pilot oil passage 33, a reduced section 38 may be provided for the oil discharge passage 35. In this case, the reduced section 38 may be provided for a portion of the oil discharge passage 35 which portion is downstream from the low-pressure relief valve 36, or the reduced section 38 may be provided for a portion of the oil discharge passage 35 between the pilot oil passage 33 and the low-pressure relief valve 36.

In the configuration illustrated in FIG. 4, in a case where the selector valve 27 is switched to the second position 27b, the pilot hydraulic oil in the pilot oil passage 33 is rapidly discharged from the selector valve 27 (in the second position 27b), so that the mixing valve 25 is rapidly switched to the diverting position 25b.

In the meantime, in a case where the low-pressure relief valve 36 is opened, the pilot hydraulic oil in the pilot oil passage 33 is gradually discharged from the low-pressure relief valve 36 and the oil discharge passage 35 (the reduced section 38), so that the mixing valve 25 is gradually switched to the diverting position 25b.

In the above configuration, the oil discharge passage 35 connected to the pilot oil passage 33 is provided, and the reduced section 38 and the low-pressure relief valve 36 (the release unit) (the relief valve) are provided for the oil discharge passage 35.

### Second Modification of Invention

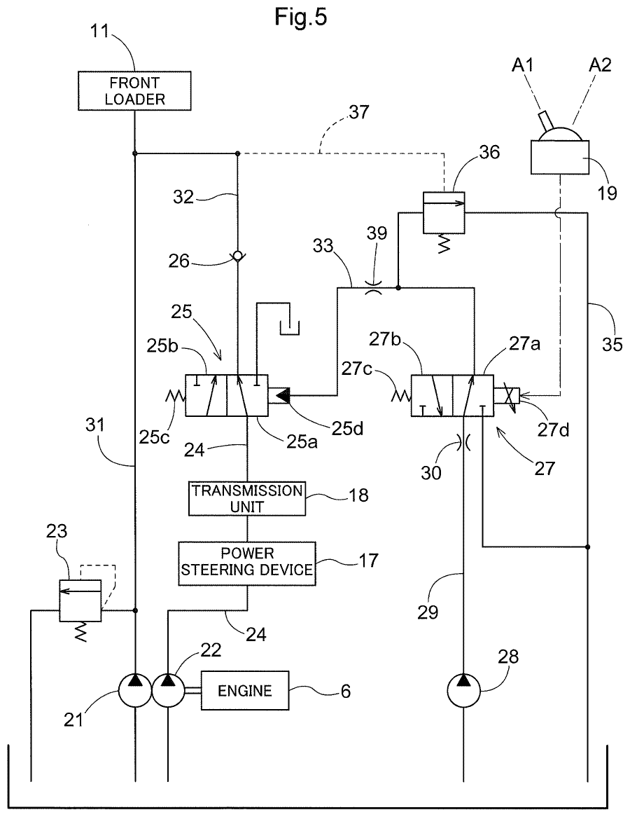

As illustrated in FIG. 5, instead of the reduced section 34 (see FIGS. 2 and 3) provided for the pilot oil passage 33 and the reduced section 38 (see FIG. 4) provided for the oil discharge passage 35, a reduced section 39 may be provided for a portion of the pilot oil passage 33 between the switching section 25d of the mixing valve 25 and a portion connected to the oil discharge passage 35 (the low-pressure relief valve 36).

In the configuration illustrated in FIG. 5, in response to the selector valve 27 being switched to the second position 27b, the pilot hydraulic oil in the pilot oil passage 33 is gradually discharged from the reduced section 39 and the selector valve 27 (the second position 27b), so that the mixing valve 25 is gradually switched to the diverting position 25b.

Similarly to this, in a case where the low-pressure relief valve 36 is opened, the pilot hydraulic oil in the pilot oil passage 33 is gradually discharged from the reduced section 39 and the low-pressure relief valve 36, so that the mixing valve 25 is gradually switched to the diverting position 25b.

In the above configuration, the reduced section 39 is provided for a portion of the pilot oil passage 33 between the mixing valve 25 and a portion connected to the low-pressure relief valve 36 (the release unit) (the relief valve).

### Third Modification of Invention

In the configuration illustrated in FIG. 5, in addition to the reduced section 39, the reduced section 34 illustrated in FIGS. 2, 3 may be provided for a portion of the pilot oil passage 33 between the selector valve 27 and a portion connected to the oil discharge passage 35 (the low-pressure relief valve 36).

An adjustment section (not illustrated) configured to increase or decrease the second setting pressure (the setting pressure) to open the low-pressure relief valve 36 may be provided.

### Fourth Modification of Invention

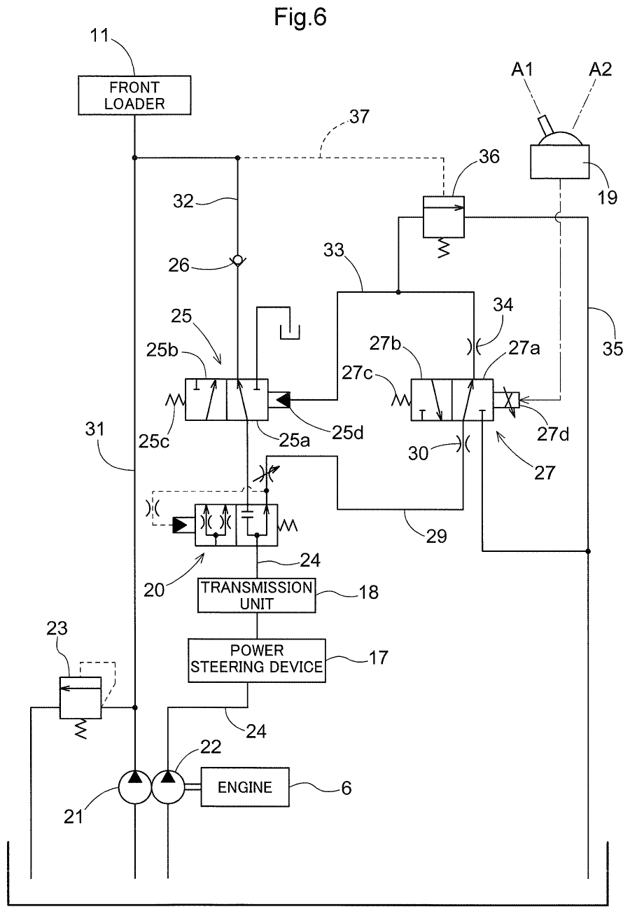

The pilot pump 28 may not be provided in the configurations illustrated in FIGS. 2 to 5 so as to achieve the configuration in FIG. 6.

As illustrated in FIG. 6, the oil supply passage 24 includes a priority valve 20, and the oil supply passage 29 is extended from the priority valve 20 and connected to the selector valve 27. Even when the hydraulic pressures in the oil supply passages 24, 29 fluctuate, the hydraulic oil is supplied to the selector valve 27 constantly at a small flow rate as the pilot hydraulic oil from the priority valve 20, and remaining hydraulic oil is supplied from the priority valve 20 to the mixing valve 25.

### Fifth Modification of Invention

In the configurations illustrated in FIGS. 2 to 6, the selector valve 27 may be a pilot-operated valve instead of a solenoid-operated valve.

In this configuration, pilot hydraulic oil tapped off from the oil supply passage 29 is supplied to a pilot valve (not illustrated) to switch the pilot valve, so that the pilot hydraulic oil is supplied to the selector valve 27 from the pilot valve to switch the selector valve 27.

### Sixth Modification of Invention

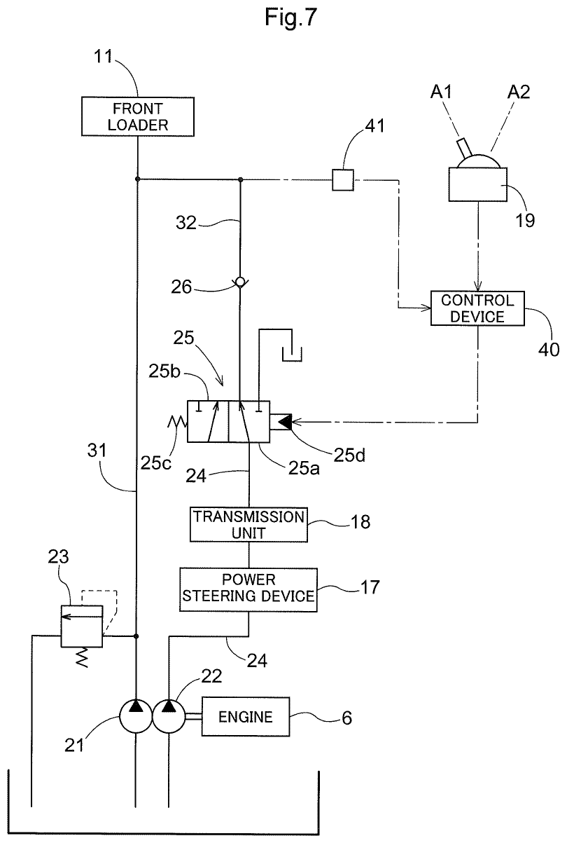

The selector valve 27, the pilot oil passage 33, the oil discharge passage 35, the low-pressure relief valve 36, and so on in FIG. 2 may not be provided, and the configuration illustrated in FIG. 7 may be employed,

As illustrated in FIG. 7, the mixing valve 25 is a solenoid-operated valve switchable between the mixing position 25a and the diverting position 25b and is biased to the diverting position 25b by the spring 25c. The mixing valve 25 is switched to the mixing position 25a against the spring 25c of the mixing valve 25 in response to operation electric power being supplied to the switching section 25d of the mixing valve 25.

A control device 40 (corresponding to a release unit) is provided, and an operation signal from the operating section 19 is input into the control device 40. In response to the operating section 19 being operated to the first operation position Al, the control device 40 causes operation electric power to be supplied to the switching section 25d of the mixing valve 25 based on the operation signal from the operating section 19, so that the mixing valve 25 is switched to the mixing position 25a.

In response to the operating section 19 being operated to the second operation position A2, the control device 40 stops the supply of the operation electric power to the switching section 25d of the mixing valve 25 based on the operation signal from the operating section 19, so that the mixing valve 25 is switched to the diverting position 25b.

A pressure sensor 41 (corresponding to the release unit) configured to detect the hydraulic pressure in a portion of the second oil supply passage 32 between the first oil supply passage 31 and the check valve 26 is provided, and a detection value from the pressure sensor 41 is input into the control device 40.

In response to the detection value of the pressure sensor 41 becoming higher than the second setting pressure (the setting pressure) while the operating section 19 is in the first operation position A1 (while the mixing valve 25 is in the mixing position 25a), the control device 40 stops the supply of the operation electric power to the switching section 25d of the mixing valve 25 and switches the mixing valve 25 to the diverting position 25b.

The control device 40 may be configured such that, in response to the operating section 19 being operated to the second operation position A2, the control device 40 gradually decreases the operation electric power supplied to the switching section 25d of the mixing valve 25 so that the mixing valve 25 is gradually switched to the diverting position 25b.

The control device 40 may be configured such that, in response to the detection value of the pressure sensor 41 becoming higher than the second setting pressure (the setting pressure), the control device 40 gradually decreases the operation electric power supplied to the switching section 25d of the mixing valve 25 so that the mixing valve 25 is gradually switched to the diverting position 25b.

The second setting pressure (the setting pressure) may be determined based on an operation position of the adjustment section operated by the operator, so that the second setting pressure (the setting pressure) may be increased or decreased by the operator operating the adjustment section.

### Seventh Modification of Invention

In the configuration illustrated in FIG. 7, like the configuration to be described below, the selector valve 27 may be configured to change the pressure of the pilot hydraulic oil, and the mixing valve 25 (in the mixing position 25a) may be configured to change the flow rate of the hydraulic oil to the second oil supply passage 32.

The operating section 19 is a dial operation section configured such that the operating section 19 is operable to a given position between the first operation position A1 and the second operation position A2.

In response to the operating section 19 being operated to the second operation position A2, the control device 40 switches the selector valve 27 to the second position 27b, so that the mixing valve 25 is switched to the diverting position 25b.

In response to the operating section 19 being operated to a given position between the first operation position Al and the second operation position A2, the control device 40 switches the selector valve 27 to the first operation position A1. In this case, as the operation position of the operating section 19 is closer to the first operation position A1, the pressure of the pilot hydraulic oil controlled by the selector valve 27 increases, so that the flow rate of the hydraulic oil from the mixing valve 25 (in the mixing position 25a) to the second oil supply passage 32 increases.

While the operation position of the operating section 19 is the first operation position A1, the pressure of the pilot hydraulic oil controlled by the selector valve 27 becomes maximum, so that the flow rate of the hydraulic oil from the mixing valve 25 (in the mixing position 25a) to the second oil supply passage 32 becomes maximum.

### Eighth Modification of Invention

Instead of the front loader 11, another work device such as a mowing machine (a blade mower or a flail mower) (not illustrated), for example, may be provided as the first work device.

The second work device is not limited to the power steering device 17 or the transmission unit 18, and other work devices may be provided as the second work device instead of the power steering device 17 and the transmission unit 18.

### Ninth Modification of Invention

Instead of detecting the hydraulic pressure in the second oil supply passage 32, a load applied to the first work device may be detected by a load sensor provided for the first work device.

Instead of the engine 6, the first hydraulic pump 21 and the second hydraulic pump 22 may be driven by an electric motor (not illustrated) as the motor unit.

The first hydraulic pump 21 and the second hydraulic pump 22 may be driven by a hybrid motor unit that combines the engine 6 and the electric motor (not illustrated).

### INDUSTRIAL APPLICABILITY

The present invention is not limited to a tractor but is also applicable to a work vehicle including a first hydraulic pump and a second hydraulic pump that can supply hydraulic oil to a first work device attached to a body of the work vehicle, e.g., a work vehicle for construction such as a backhoe or a wheel loader.

### DESCRIPTION OF REFERENCE NUMERALS

11: front loader (first work device)
17: power steering device (second work device)
18: transmission unit (second work device)
21: first hydraulic pump
22: second hydraulic pump
25: mixing valve
25a: mixing position
25b: diverting position
25d: switching section
26: check valve
27: selector valve
27a: first position
27b: second position
31: first oil supply passage
32: second oil supply passage
33: pilot oil passage
34: reduced section
35: oil discharge passage
36: low-pressure relief valve (release unit) (relief valve)
38: reduced section
39: reduced section
40: control device (release unit)
41: pressure sensor (release unit)

1. A work vehicle, comprising:
a first hydraulic pump;
a second hydraulic pump;
a first work device;
a first oil supply passage causing hydraulic oil in the first hydraulic pump to be supplied to the first work device;
a mixing valve to which hydraulic oil in the second hydraulic pump is supplied;
a second oil supply passage connected to the first oil supply passage and the mixing valve; and
a release unit configured to switch the mixing valve from a mixing position to a diverting position based on a load applied to the first work device, the mixing position being a position allowing the hydraulic oil in the second hydraulic pump to be supplied to the first oil supply passage through the second oil supply passage, the diverting position being a position preventing the hydraulic oil in the second hydraulic pump from being supplied to the first oil supply passage and the second oil supply passage.

2. The work vehicle according to claim 1, further comprising
a second work device, wherein
the hydraulic oil in the second hydraulic pump is supplied to the second work device and then supplied to the mixing valve from the second work device.

3. The work vehicle according to claim 1, wherein
the load applied to the first work device is hydraulic pressure in the second oil supply passage, and
the release unit switches the mixing valve to the diverting position in response to the hydraulic pressure in the second oil supply passage becoming higher than a setting pressure determined in advance.

4. The work vehicle according to claim 3, wherein
the mixing valve is a pilot-operated valve biased to the diverting position and includes a switching section configured to switch the mixing valve to the mixing position upon receipt of pilot hydraulic oil,
the work vehicle further comprises a selector valve, and a pilot oil passage connected to the switching section of the mixing valve and the selector valve,
the selector valve is switchable between (i) a first position allowing the pilot hydraulic oil to be supplied from the pilot oil passage to the switching section of the mixing valve to switch the mixing valve to the mixing position and (ii) a second position causing the pilot hydraulic oil to be discharged from the switching section of the mixing valve through the pilot oil passage to switch the mixing valve to the diverting position, and
the release unit is a relief valve configured to switch the mixing valve to the diverting position by discharging the pilot hydraulic oil from the pilot oil passage in response to the hydraulic pressure in the second oil supply passage becoming higher than the setting pressure.

5. The work vehicle according to claim 4, further comprising:
a check valve provided for the second oil supply passage and configured to prevent the hydraulic oil from the first oil supply passage from flowing toward the mixing valve, wherein
the relief valve discharges the pilot hydraulic oil from the pilot oil passage in response to the hydraulic pressure in a portion of the second oil supply passage between the first oil supply passage and the check valve becoming higher than the setting pressure.

6. The work vehicle according to claim 4, wherein
the pilot oil passage includes a reduced section provided between the selector valve and a portion connected to the relief valve.

7. The work vehicle according to claim 4, further comprising:
an oil discharge passage connected to the pilot oil passage and including a reduced section and the relief valve.

8. The work vehicle according to claim 4, wherein
the pilot oil passage includes a reduced section provided between the mixing valve and a portion connected to the relief valve.
